(19) United States
(12) Patent Application Publication
(10) Pub. No.: US 2008/0029206 A1
(43) Pub. Date: Feb. 7, 2008

(54) Concrete mixer drum and method of manufacture

(76) Inventors: Tim R. Boesch, Otsego, MN (US); Travis J. Boesch, Burnsville, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/890,797

(22) Filed: Aug. 6, 2007

Related U.S. Application Data
(60) Provisional application No. 60/835,930, filed on Aug. 4, 2006.

(51) Int. Cl. B28B 3/20; B29C 47/00

(52) U.S. Cl. 156/244.27; 425/364 R

(57) ABSTRACT

A reconfigurable material press having a first portion and a second portion. The first portion includes a frame, a plurality of plates releasably coupled to the frame, and a pressing surface. Each plate has a semi-circular profile. The second portion includes a plurality of support structures generally longitudinally parallel and laterally spaced apart from one another, and a top plate slidably coupled to each support structure and having a forming edge. Each top plate is configured to be laterally adjustable, and the top plates define a channel therebetween.

### RELATED APPLICATION

The present application claims the benefit of U.S. Provisional Application No. 60/835,930 filed Aug. 4, 2006, which is incorporated herein in its entirety by reference.

### FIELD OF THE INVENTION

The present invention relates generally to concrete mixing drums for concrete trucks. More specifically, the present invention relates to steel mixing drums, apparatus for forming the drums, and methods of drum manufacture.

### BACKGROUND OF THE INVENTION

The building industry makes widespread use of concrete mixing trucks for transportation of ready mixed concrete to sites for concrete pours. These trucks typically comprise a large mixing assembly including a mixer drum mounted to the vehicle and which is connected to a mixer drive for mixing concrete contents during transportation and for discharge of the contents on site. The drive system comprises a gear box which takes power from the vehicle motor and which applies a mixing torque to the drum imparting axial rotation to the drum with the torque being adjustable depending upon the operating requirements. The above general arrangement is described in U.S. Pat. No. 4,585,356 which discloses a concrete mixer truck having a mixer drum adapted to be rotated by the traction motor of the vehicle through an auxiliary transmission of the traction motor transmission.

According to the known vehicle mounted mixing assemblies, the mixing drum is typically of heavy duty steel construction and is disposed at approximately 10 to 15 degrees from horizontal. The drum is fitted with internal vanes or mixing blades defining an archimedian spiral so that as the drum rotates in a first direction the concrete held therein is mixed and as the drum is rotated in the opposite direction, the concrete is discharged from the drum via an elevated discharge orifice under the reverse action of the internal spiral vanes. The drum is often disposed such that the drive end is lowest and the discharge end is highest relative to a generally horizontal plane of the vehicle.

While steel drums have been in use for many years, they suffer from some disadvantages, not the least of which is the cost and time required to manufacture them. Steel drums are expensive to manufacture due to their labor intensive construction. The drum is typically composed of three or more sections, and each section is formed from multiple metal sheets or panels. Each section may be divided into halves, thirds, or quadrants, and each panel is individually cut from plate steel. The cut panels are individually passed through a series of rollers which curves and shapes the panel. The rolling process is inconsistent and time consuming, as each steel piece must be passed through the rollers many times in order to curve the piece to the desired radius. As a result of being passed through the rollers over and over, the edges of the steel pieces become warped.

To create a drum, the steel panels must be welded together along their interfacing edges, and if the edges are warped they must be manually hammered, pried, heated, and/or clamped in order to be aligned for welding. Some of the panels, particularly the panels making up the rear cone section of the drum, have a large surface area and must be of sufficient thickness to withstand the weight and in-transit jostling of the cement being mixed within. Consequently, individual panels are heavy and difficult to handle, making the welding of these panels a cumbersome, time consuming process. Overhead cranes or the like are typically needed to handle subassemblies.

A need exists, therefore, for a device that eases the production of steel cement mixing drums, and for an improved method of manufacturing steel cement mixing drums.

### SUMMARY OF THE INVENTION

In one embodiment, the present invention comprises a multi-piece press having an upper portion and a lower portion. The upper portion and lower portion are each constructed from a plurality of individual plates stacked together, and clamped to one another with multiple fasteners extending through the plurality of plates. Each portion of the press includes a pressing surface having a defined profile, the profile determining the finished shape of a pressed piece of material. The profile of each portion is dependent upon one or more features of each individual plate and can be varied by varying the one or more features. The multi-piece press is suitably configured for creating panels used for cement mixing drums.

In one embodiment, the present invention is a reconfigurable material press for creating curved panels, comprising a first portion including a frame, a plurality of plates releasably coupled to the frame, each plate having a semi-circular profile, and a pressing surface. A second portion includes a plurality of support structures generally longitudinally parallel and laterally spaced apart from one another, and a top plate slidably coupled to each support structure and having a forming edge, each top plate configured to be laterally adjustable, the top plates defining a channel therebetween, wherein the pressing surface of the first portion is configured to be received in the channel of the second portion during operation of the press.

In one embodiment, the present invention is a method of manufacturing, comprising providing a material press, the press including a first portion having a frame, a plurality of plates releasably coupled to the frame, each plate including a semi-circular profile, and a pressing surface. A second portion includes a plurality of support structures generally longitudinally parallel and laterally spaced apart from one another, and a top plate slidably coupled to each support structure, each top plate configured to be laterally adjustable, and the top plates defining a channel therebetween. The method further comprises providing a material blank between the first portion and second portion, and advancing the first portion and second portion together such that the pressing surface is received in the channel, thereby conforming the material blank between the pressing surface and the forming edges of the top plates to create a curved panel.

In one embodiment, the present invention is a material press comprising a first portion, including a pressing surface and a means for varying the shape of the pressing surface, and a second portion, including a plurality of support structures being spaced apart and a top plate coupled to each support structure, the top plates defining a channel therebetween, and a means for varying the shape of the channel, wherein the press is configured to form a curved panel of material by advancing the first portion and the second portion together such that the pressing surface is received within the channel.

In one embodiment, the present invention is a method of manufacturing cylindrical drums of varying sizes, comprising configuring a first pressing surface on a first portion of a press, configuring a channel in an opposing portion of the press, the channel sized to receive the first pressing surface during operation of the press, providing a material blank between the first portion and the opposing portion, introducing the first pressing surface into the channel, thereby forming the blank into a panel having the shape of the first pressing surface, repeating the previous steps to form multiple panels having the shape of the first pressing surface, and joining the panels together to form a cylindrical drum.

### BRIEF DESCRIPTION OF THE DRAWINGS

The present invention can be more completely understood and appreciated by referring to the following more detailed description of the presently preferred exemplary embodiments of the invention in conjunction with the accompanying drawings, of which:

FIG. 1 is a perspective view of a cement truck.

FIG. 2 is a perspective view of a multi-piece, reconfigurable press according to an embodiment of the present invention.

FIG. 3 is an overhead view of the lower portion of a press according to an embodiment of the present invention.

FIG. 4A is a front view of a plate for the lower portion of a press according to an embodiment of the present invention.

FIG. 4B is a front view of a plate for the lower portion of a press according to an embodiment of the present invention.

FIG. 5A is a front view of a plate for the upper portion of a press according to an embodiment of the present invention.

FIG. 5B is a front view of a plate for the upper portion of a press according to an embodiment of the present invention.

FIG. 6 is a perspective view of a multi-piece, reconfigurable press according to another embodiment of the present invention.

FIG. 7 is an exploded view of a first portion of a press according to an embodiment of the present invention.

FIG. 8 is an exploded view of a second portion of a press according to an embodiment of the present invention.

### DETAILED DESCRIPTION OF THE DRAWINGS

In the following detailed description of the present invention, numerous specific details are set forth in order to provide a thorough understanding of the present invention. However, it will be apparent to one skilled in the art that the present invention may be practiced without these specific details. In other instances, well-known methods, procedures, and components have not been described in detail so as to not unnecessarily obscure aspects of the present invention.

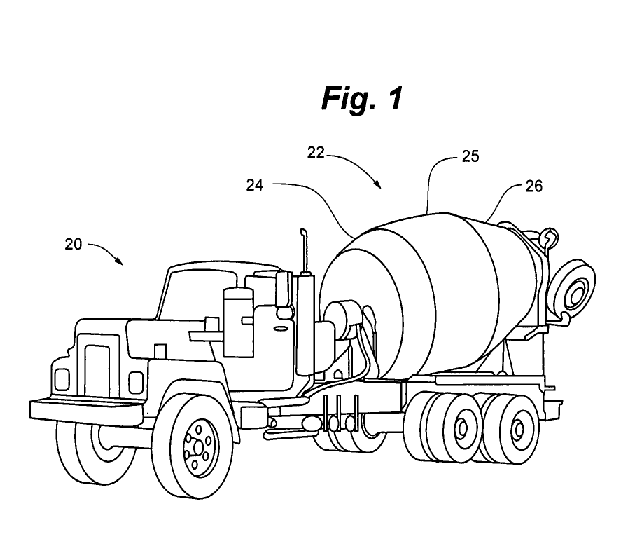

Referring to FIG. 1, a typical cement truck 20 is depicted, having a cement mixing drum 22. Cement mixing drum 22 is constructed from a plurality of sections, in the embodiment of FIG. 1, mixing drum 22 is constructed from three sections: a forward section 24, middle section 25, and rear section 26. It will be appreciated by one skilled in the art that mixing drum 22 may be constructed from more or less sections, depending on the desired application. Each section of drum 22 is constructed of multiple curved steel segments or panels, which are welded together to form a circumferential section of drum 22.

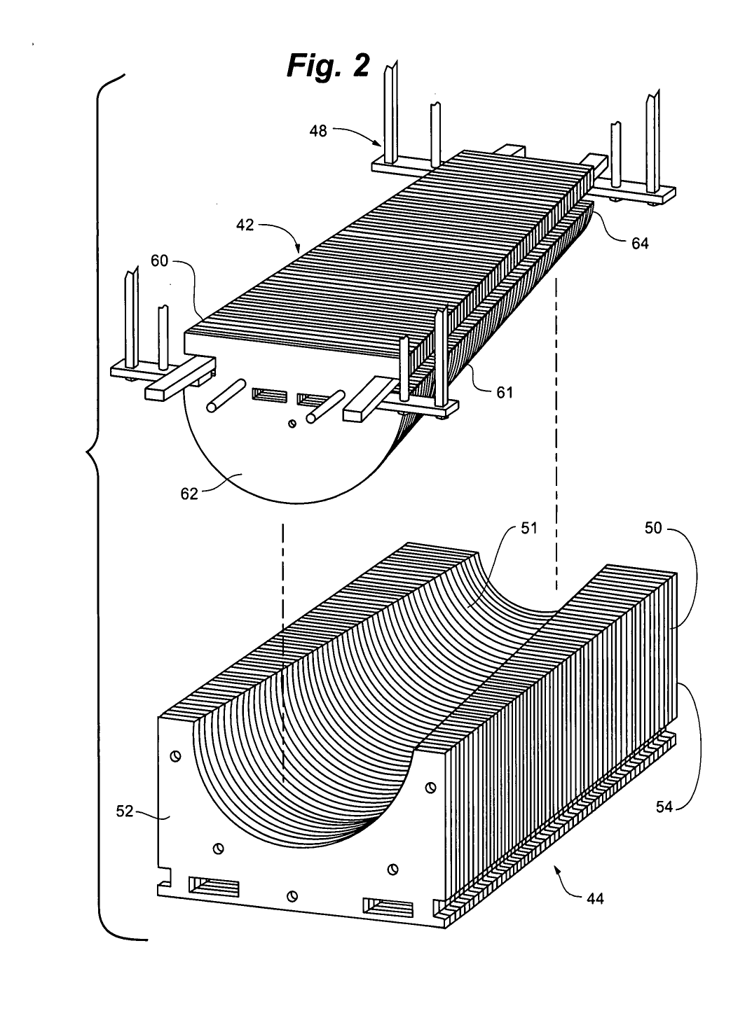

Referring to FIGS. 2-5B, one embodiment of the present invention is depicted. Multi-piece reconfigurable press 40 includes a lower portion 44 having a first end 52 and a second end 54, and being composed of a plurality of pressing plates 50, each pressing plate 50 being stacked against one another to form the structure of lower portion 44. Each plate 50 in lower portion 44 includes a notch or relief 56 suitable for mounting, securing, supporting, or otherwise holding lower portion 44. Features such as passageways 57 may be included in plates 50 of lower portion 44, and passageways 57 are configured to receive the forks of a common forklift, allowing lower portion 44 to be transported. Multiple bores 58 are provided in lower portion 44, wherein bores 58 are configured to receive fasteners such as bolts. In one embodiment, the plurality of bottom plates 50 are secured to one another by passing bolts through bores 58, and clamping plates 50 together by tightening a nut down onto the bolt. Lower portion 44 includes a pressing surface 51 defined by the plurality of plates 50, wherein a blank 80 will be pressed into surface 51 during the pressing process. Lower portion 44 may be mounted so as to be immovable, or may be mounted to a moveable device such as a hydraulic ram.

In one embodiment, surface 51 may have a tapered profile so as to create a conical-shaped steel piece for use in creating a drum 22. In other embodiments, surface 51 may comprise other profiles depending on the desired application. For example, to create a middle section 25 of drum 22 in FIG. 1, the profile of surface 51 would be cylindrical and non-tapered. The profile of surface 51 is dictated by the radius of curvature of each plate 50.

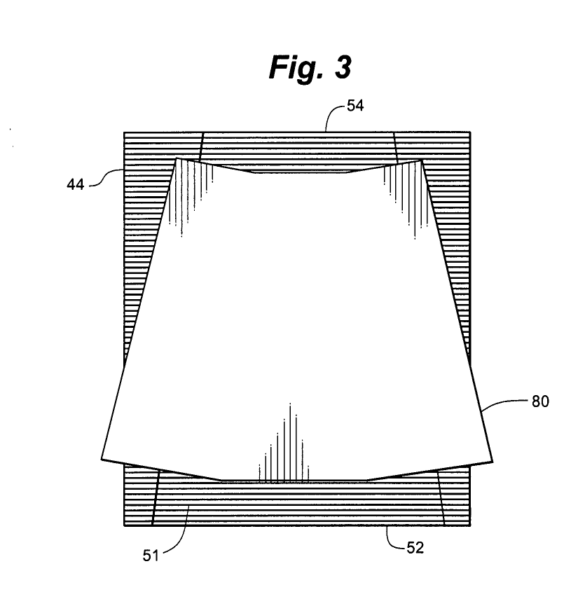

Referring now to FIG. 3, a blank 80 is depicted in conjunction with lower portion 44. In FIG. 3, blank 80 has not yet been pressed. Preferably, the size of surface 51 of lower portion 44 is larger than the size of a blank 80 which will be pressed on it. Blank 80 may comprise steel, other metals, or other robust materials. In an embodiment wherein blank 80 comprises steel, a typical thickness is about one quarter-inch. However, it will be apparent that the thickness of blank 80 may vary depending on the desired application.

In one embodiment depicted in FIGS. 2-5B, first end 52 includes a plate 50 having a radius RI, with top measurement L1. Second end 54 includes a plate 50 having a radius R2, and top measurement L2. To create a tapered profile on surface 51, R1 is larger than R2, and L1 is smaller than L2. Starting from first end 52, each sequential plate 50 will have a slightly smaller radius than R1, and a slightly larger top measurement than L1, until getting to second end 54, where plate 50 will have a radius of R2 and a top measurement of L2. The profile of surface 51 can be varied to the desired application by varying the relationship between R1 and R2, and L1 and L2.

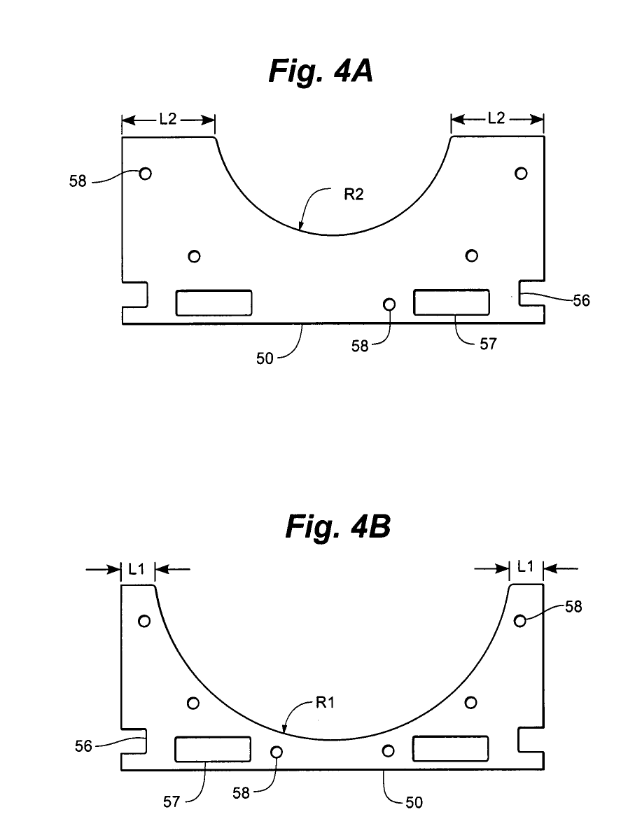

Examples of plates 50 are depicted in FIGS. 4A-4B, with a plate 50 corresponding to first end 52 of lower portion 44 depicted in FIG. 4B, and a plate 50 corresponding to second end 54 of lower portion 44 in FIG. 4A.

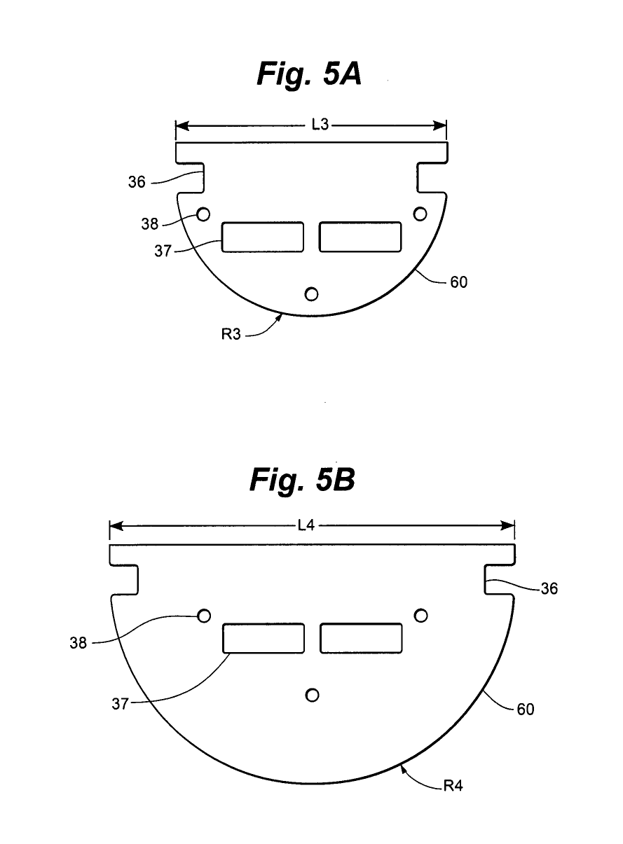

Referring now to FIGS. 5A-5B, upper portion 42 of multi-piece press 40 is depicted. Upper portion 42 includes a first end 62, a second end 64, and is composed of a plurality of plates 60, each plate 60 being stacked against one another to form the structure of upper portion 42. Upper portion 42 includes a notch or relief 66 suitable for mounting, securing, supporting, or otherwise holding upper portion 42, such as to frame 48 in FIG. 2. Upper portion 42 may be coupled to a movable device such as a hydraulic ram, or lowered from an overhead crane or similar apparatus. Features such as passageways 57 may be included in upper portion 42, and passageways 67 are configured to receive the forks of a common forklift, allowing upper portion 42 to be transported or operated. Multiple bores 68 are provided in upper portion 42, wherein bores 68 are configured to receive fasteners such as bolts. In one embodiment, the plurality of plates 60 are secured to one another by passing bolts through bores 68, and clamping plates 60 together by tightening a nut down onto the bolt.

Upper portion 42 includes a pressing surface 61 defined by the edges of the plurality of plates 60, wherein a steel blank 80 will be pressed into surface 81 during the formation of a piece for drum 22. Surface 61 is a mirror-image of surface 51 of lower portion 44. In one embodiment, surface 61 may have a tapered profile so as to create a conical-shaped section of finished steel. In other embodiments, surface 61 may comprise other profiles depending on the desired application. The profile of surface 61 is dictated by the radius of curvature of each plate 60. In one embodiment, the size of surface 61 of upper portion 42 is larger than the size of a steel blank 80 which will be pressed beneath it.

In one embodiment, first end 62 includes a plate 60 having a radius R4, with top measurement L4. Second end 64 includes a plate 60 having a radius R3, and top measurement L3. To create a tapered profile on surface 61, R4 is larger than R3, and L3 is smaller than L4. Starting from first end 62, each sequential plate 60 will have a slightly smaller radius than R4, and a slightly smaller top measurement than L4, until getting to second end 64 where plate 60 will have a radius of R3 and a top measurement of L3. The profile of surface 61 can be varied to the desired application by varying the relationship between R3 and R4, and L3 and L4.

Examples of plates 60 are depicted in FIGS. 5A and 5B, with a plate 60 corresponding to first end 62 of upper portion 42 depicted in FIG. 5B, and a plate 60 corresponding to second end 64 of upper portion 42 in FIG. 5A.

Referring now to the manufacturing and assembly of multi-piece press 40, as discussed above each upper portion 42 and lower portion 44 are constructed from many individual plates 50 and 60, respectively. Each plate may be cut to the desired shape by any suitable process, such as laser cutting, water-jet cutting, conventional milling, computer numerical control milling, or other. The thickness of each plate is preferably consistent, and in one embodiment each plate is one quarter-inch thick. As discussed above, the radius and top measurement of each plate may be varied to create a desired profile to the pressing surface. Additional features such as holes for fastening the plates together, and holes for accepting forklift forks, are also cut into each plate. When all the plates necessary to create a portion of multi-piece press have been manufactured, they are assembled in the proper order, and fastened together. In one embodiment, long bolts are passed through the length of plates, and secured with a nut, thereby clamping all of the plates together. Once assembled, a portion of multi-piece press is either fixed in position, or mounted to a movable device. One portion of the press must be moveable, and the other portion may be fixed or moveable. In one embodiment, lower portion 44 is fixed in place, while upper portion 42 is coupled to a movable device, such as a hydraulic or pneumatic device.

To create a section of a truck-mounted cement mixing drum 22 with press 40, a steel blank 80 is placed on surface 51 of lower portion 44, and aligned into place. Upper portion 42 is pressed down against steel blank 80, with first end 62 of upper portion 42 aligning with first end 52 of lower portion 44, and second end 64 of upper portion 42 aligning with second end 54 of lower portion 44, until blank 80 conforms to the shape of surface 51 and surface 61. The finished steel panel, comprising part of a section, may then be welded to one or more other finished panels to form a complete section of drum 22. By having multiple presses 40, one for each section of cement mixing drum 22, a finished drum can be quickly produced. In another embodiment, press 40 is reconfigured to produce panels for each necessary section of drum 22.

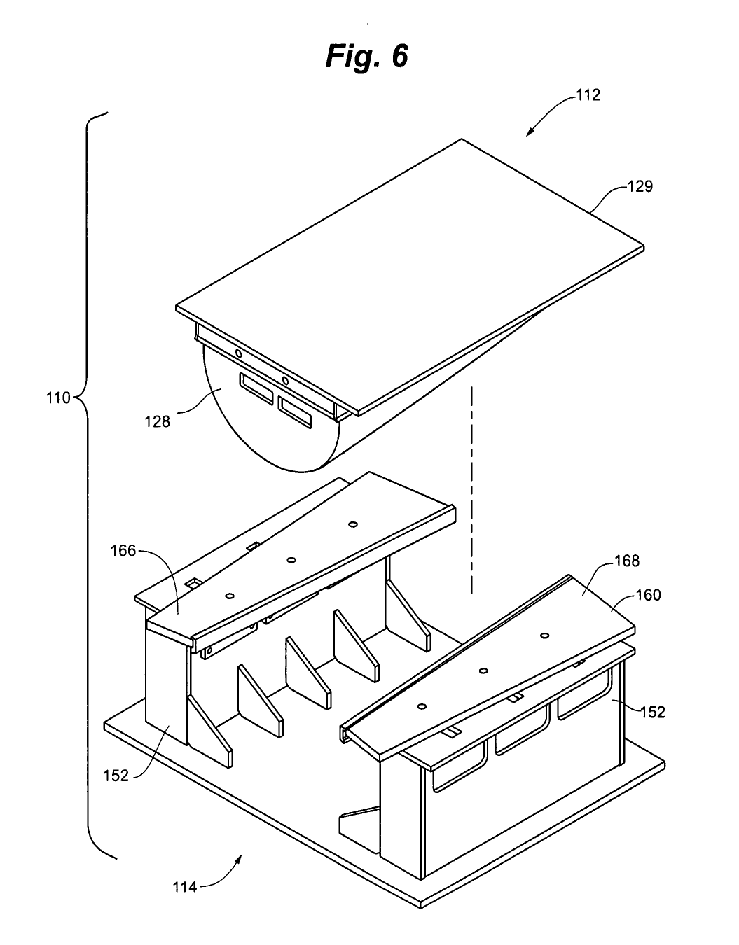

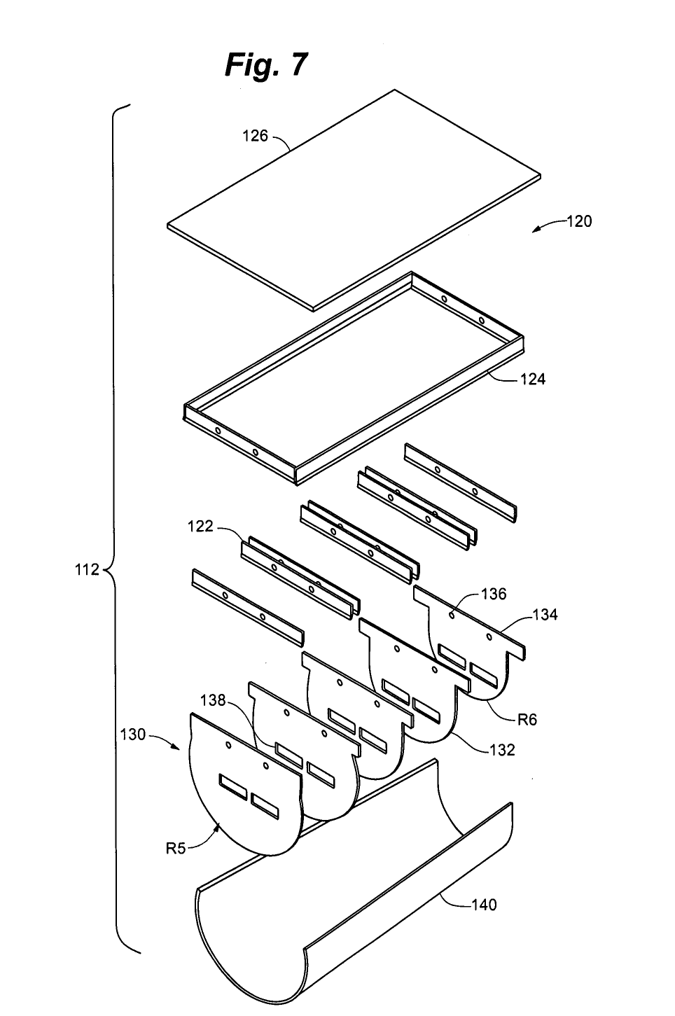

Referring now to FIGS. 6-8, a further embodiment of the present invention is depicted. Adjustable, reconfigurable press 110 comprises a first portion 112 and a second portion 114.

First portion 112 may comprise a frame 120 having multiple receiving channels 122, each configured to receive plates 130. In one embodiment, frame 120 includes rails 124 that define a maximum width of channels 122, and therefore plates 130. A mounting plate 126 may be provided, to which channels 122 and rails 124 are secured. Frame 120 may further include hooks or other features or structure to facilitate transport or operation, such as by overhead crane. Receiving channels 122 may include bores 127 to facilitate retention of plates 130, such as by bolts or other suitable fastening arrangements. First portion 112 includes a first end 128, and a second end 129. First portion 112 may be coupled to a movable device such as a hydraulic ram, or lowered from an overhead crane or similar apparatus.

Channels 122 may be permanently fixed to frame 120 in one embodiment, such as by welding. In another embodiment, channels 122 may be adjustably coupled to frame 120 such that the spacing between successive channels 122 can be increased or decreased, or the number of channels coupled to frame 120 may be increased or decreased, depending on the desired application. Frame 120 may include multiple mounting holes to allow for adjustability of the quantity and/or spacing of channels 122.

Frame 120 is preferably sized so as to be able to manufacture the largest necessary piece for creating a cement mixing drum 22. Frame 120 can be adjusted to create pieces for smaller sections of drum 22, by adjusting the spacing and/or quantity of channels 122.

Each plate 130 includes a profiled edge 132, a mounting portion 134, one or more attachment bores 136, and one or more passageways 138. Profiled edge 132 is arcuate, and may be of a constant or variable radius. Mounting portion 134 is configured to couple plate 130 to a channel 122 in frame 120, such as with the use of attachment bores 136 which are configured to allow the use of bolts or other fasteners to secure plate 130 to frame 120. Features such as passageways 138 may be provided to facilitate the operation of, or transport of, first portion 112. In one embodiment, passageways 138 are configured to receive the forks of a forklift. Plate 130 is arranged to be transverse to mounting plate 126 of frame 120.

In one embodiment, a steel sheet is secured to the edges of plates 130, such as by tack-welding, to define a pressing surface 140. In another embodiment, profiled edges 132 of plates 130 define a pressing surface 140.

In one embodiment, first end 128 includes a plate 130 having a radius R5, and second end 129 includes a plate 130 having a radius R6. In one embodiment wherein pressing surface 140 is tapered, R5 and R6 are different values with plates 130 between first end 128 and second end 129 having radii between R5 and R6. In another embodiment, the radii of each plate 130 is equal, thereby creating a uniformly cylindrical pressing surface 140.

Manufacture of plates 130 may be similar to the manufacture of plates 50 and 60, as discussed above.

Second portion 114 comprises a plurality of support structures 152 arranged to create a channel therebetween configured for receiving first portion 112 during operation of forming portions of a mixer drum 22. Support structures 152 are sized according to the desired application, wherein the length, height, and distance between each support structure 152 is selected based on the maximum foreseeable size necessary to form pieces of mixing drum 22. Support structures 152 are oriented to be generally parallel in a longitudinal direction. Each support structure 152 may include internal ribs for added strength. Support structures 152 may be securely mounted to the floor of a manufacturing facility, or to a base 156. One or more buttresses 158 may be provided on support structures 152. Support structure also includes a plurality of adjustment slots 159.

An adjustable top plate 160 is provided on each support structure 152. Top plate 160 includes a forming edge 162, and a plurality of mounting holes 164 through which top plate 160 may be coupled to support structure 152. Forming edge 162 is preferably radiused, and may comprise a separate piece of material which is secured to top plate 160, such as a material having a hardness greater than that of top plate 160. Top plate 160 may be generally rectangular, or polygonal, and includes a first end 166 and a second end 168. In one embodiment, support structure 152 lacks a separate top plate 160. Rather, each support structure 152 is adapted to be positionally adjustable with respect to one another so as to provide multiple configurations for pressing. Top plate 160 is configured to be laterally adjustable.

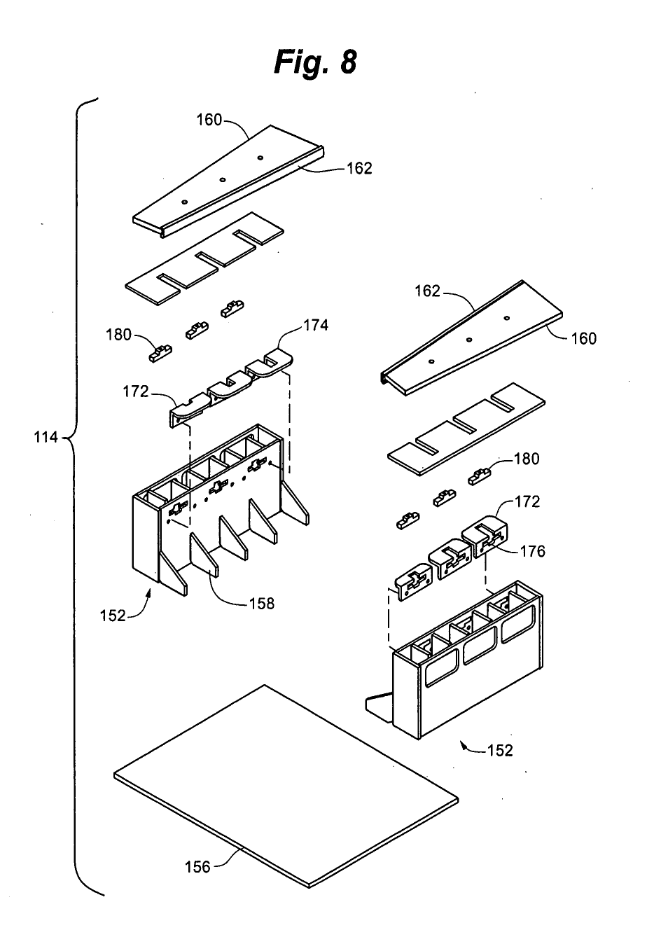

One or more reinforcement members 172 may be included in second portion 114, as best depicted in FIG. 8. Reinforcement members 172 may be L-shaped, wherein one portion of member 172 is secured to support structure 152, and wherein a horizontal protrusion is configured to support top plate 160. In the embodiment depicted in FIGS. 6 and 8, each support structure 152 includes three reinforcement members 172, although it will be apparent that more or fewer reinforcement members can be used as needed. Each member 172 includes a positioning slot 176, which is aligned with slot 159 on support structure 152 and configured to allow positional adjustment of top plate 160. Each member 172 may be of similar size, or may be variably sized as needed for the particular application, as depicted in FIG. 8.

A guide block 180 may be provided, configured to be at least partially received in slots 159 and 176 and adapted to facilitate coupling of top plate 160 to support structure 152. In one embodiment, fasteners are inserted through mounting bores 164 in top plate 160 and secured to guide block 180 to clamp top plate 160 to support structure 152.

Referring now to the operation of press 110, a material blank 80 is positioned and aligned on second portion 114. First portion 112 is advanced toward second portion 114, or vice versa, with first end 128 of first portion 112 aligned with first end 166 of second portion 114, and second end 129 of first portion 112 aligned with second end 168 of second portion 114. First portion 112 and second portion 114 are advanced into the other, with pressing surface 140 being received between top plates 160, causing material blank 80 to conform between forming edges 162 and pressing surface 140. The resulting formed panel, comprising part of a section of a mixing drum 22, may then be welded to one or more other formed panels to create a complete section of drum 22.

Press 110 includes a number of means for adjusting or reconfiguring one or more characteristics of the press. Referring to first portion 112, the number of plates 130 on frame 120 and/or the spacing between said plates can be changed. The radius of each plate 130 may also be changed, so as to create formed curved panels of varying geometries. For example, a first portion 112 wherein the radius of each plate 130 is identical will result in a formed panel having a constant radius, suitable for creating middle section 25 of drum 22. In another example, a first portion 112 wherein the radius of each plate 130 changes from R5 at first end 128 to R6 at second end 129 will result in a formed panel having a somewhat conical geometry, suitable for creating conical sections 24 and 26 of drum 22.

Referring now to a means for adjusting one or more characteristics of second portion 114, the position of top plates 160 can be changed to adjust the distance between forming edges 162, and therefore the shape of the channel defined between top plates 160. Top plates 160 must be positioned so as to receive pressing surface 140 of first portion 112 during a pressing operation. Guide blocks 180 are slidably retained in slots 159 and/or 176, thereby allowing top plates to be translated in slots 159 and/or 176. Top plates 160 may be adjusted such that forming edges 162 are parallel, or such that forming edges are closer at first end 166 than they are at second end 168, or such that forming edges are closer at second end 166 than they are at first end 166.

It is contemplated that many or all components of presses 40 and 110 will be constructed from steel, other metals, or other suitably robust materials, due to the required material strength necessary for creating components of a mixing drum 22.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A reconfigurable material press for forming shaped panels, comprising:
a first portion, including:
a frame;
a plurality of plates releasably coupled to the frame, each plate having a semi-circular profile; and
a pressing surface; and
a second portion, including:
a plurality of support structures generally longitudinally parallel and laterally spaced apart from one another; and
a top plate slidably coupled to each support structure and having a forming edge, each top plate configured to be laterally adjustable, the top plates defining a channel therebetween, wherein the pressing surface of the first portion is configured to be received in the channel of the second portion during operation of the press.

2. The press of claim 1, wherein the semicircular profile of successive plates have an increasing or a decreasing radius.

3. The press of claim 1, wherein the semicircular profile of the plurality of plates each have an equal radius.

4. The press of claim 1, wherein the first portion includes one or more features for supporting or facilitating transport of the first portion.

5. The press of claim 1, wherein the second portion further includes a plurality of secondary support members coupled to the support structure and configured to slidably receive the top plate.

6. The press of claim 1, wherein the pressing surface is defined by the edges of the semi-circular profile of the plurality of plates.

7. The press of claim 1, wherein the pressing surface comprises a sheet coupled to the edges of the semi-circular profile of one or more of the plurality of plates.

8. A method of manufacturing, comprising:
providing a material press, the press including:
a first portion including a frame, a plurality of plates releasably coupled to the frame, each plate having a semi-circular profile, and a pressing surface; and
a second portion including a plurality of support structures generally longitudinally parallel and laterally spaced apart from one another, and a top plate slidably coupled to each support structure, each top plate configured to be laterally adjustable, and the top plates defining a channel therebetween;
providing a material blank between the first portion and second portion;
advancing the first portion and second portion together such that the pressing surface is received in the channel, thereby conforming the material blank between the pressing surface and the forming edges of the top plates to create a shaped panel.

9. The method of claim 8, further comprising:
providing a second material blank between the first portion and second portion;
advancing the first portion and second portion together to create a second shaped panel; and
joining the shaped panel and the second shaped panel together into a first cylinder.

10. The method of claim 9, further comprising:
adjusting at least one characteristic of the material press, wherein the characteristics are selected from the group consisting of: the radius of the semi-circular profile of the plates, the number of plates, the spacing between plates, and the position of the top plates with respect to one another;
advancing the first portion and second portion together to create at least two curved panels;
joining the at least two curved panels into a second cylinder; and
joining the first cylinder to the second cylinder.

11. The method of claim 10, further comprising:
adjusting at least one characteristic of the material press, wherein the characteristic is selected from the group consisting of: the radius of the semi-circular profile of the plates, the number of plates, the spacing between plates, and the position of the top plates with respect to one another;
advancing the first portion and second portion together to create at least two curved panels;
joining the at least two curved panels into a third cylinder; and
joining the third cylinder to the second cylinder, so as to create a drum suitable for mixing concrete therein.

12. A reconfigurable material press, comprising:
a first portion, including a frame configured to hold a pressing surface, and a means for varying the shape of the pressing surface; and
a second portion, including a plurality of support structures being spaced apart and a top plate coupled to each support structure, the top plates defining a channel therebetween, and a means for varying the shape of the channel, wherein the press is configured to form a curved panel of material by advancing the first portion and the second portion together such that the pressing surface is received within the channel.

13. The material press of claim 12, wherein the pressing surface is defined by a plurality of plates having a semi-circular profile.

14. The material press of claim 13, wherein the means for varying the shape of the pressing surface comprises varying the radius of some or all of the plates.

15. The material press of claim 13, wherein the frame includes a plurality of channels configured to retain the plates thereto.

16. The material press of claim 12, wherein the means for varying the shape of the channel comprises slidably adjusting the top plates.

17. A method of manufacturing cylindrical drums of varying sizes, comprising:
(a) configuring a first pressing surface on a first portion of a press;
(b) configuring a channel in an opposing portion of the press, the channel sized to receive the first pressing surface during operation of the press;
(c) providing a material blank between the first portion and the opposing portion;
(d) introducing the first pressing surface into the channel, thereby forming the blank into a panel having the shape of the first pressing surface;
(e) repeating steps (a)-(d) to form multiple panels having the shape of the first pressing surface; and
(f) joining the panels together to form a cylindrical drum.

18. The method of claim 17, further comprising:
(a) reconfiguring the first portion of the press as a second pressing surface;
(b) reconfiguring the channel in the opposing portion of the press to be sized to received the second pressing surface during operation of the press;
(c) providing a material blank between the first portion and the opposing portion;
(d) introducing the second pressing surface into the channel, thereby forming the blank into a panel having the shape of the second pressing surface;
(e) repeating steps (a)-(d) to form multiple panels having the shape of the second pressing surface; and
(f) joining the panels together to form a cylindrical drum.
